(19) United States
(12) Patent Application Publication
(10) Pub. No.: US 2010/0268750 A1
(43) Pub. Date: Oct. 21, 2010

(54) METHOD AND ELECTRONIC DEVICE FOR MANAGING CONTENT

(75) Inventors: Bei Wang, Shanghai (CN); Declan Patrick Kelly, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/741,835

(22) PCT Filed: Oct. 30, 2008
(86) PCT No.: PCT/IB2008/054509

§ 371 Date: May 7, 2010

(30) Foreign Application Priority Data
Nov. 8, 2007 (CN) 200710169507.X

(51) Int. Cl. G06F 17/30; G06F 12/00

(52) U.S. Cl. 707/813; 707/E17.044

(57) ABSTRACT

The invention provides a method and an electronic device. The electronic device (10) comprises: a receiving unit (11) for receiving a new content; a determining unit (12) for determining if the available memory space of the electronic device is insufficient; and a selecting unit (13) for selecting an old content to be re-arranged according to a pre-set instruction.

### FIELD OF THE INVENTION

The present invention relates to a method and an electronic device for managing content.

### BACKGROUND OF THE INVENTION

With the recent development of digital image technology, various mobile digital devices that can display and process digital images have come into use. Particularly, the electronic photo frame that replaces the conventional paper photo frame has been introduced on the market. For example, the electronic photo frame described in Chinese Patent No. CN200410056498X comprises a central control unit, a display panel, an internal storage unit, a transmission interface, and a controller for portable storage media. Under the control of a suitable program, the central control unit is operated to obtain external digital photos and store them in the internal storage unit, and to read the digital photos from said internal storage unit and display them on the display panel, such as a liquid crystal display screen.

With the development of network transmission technology, the electronic photo frames on the market are meanwhile capable of receiving a picture from, and especially through a network.

A new picture sharing mode has lately made its appearance. For example, some websites such as Flikr.com provide various picture sharing services, and the electronic photo frames with a picture browsing function may share pictures through these websites. This mode of sharing pictures is realized through the following operations: the electronic photo frame corresponds to the name of a member in the space of a specific group on a website; the electronic photo frame uploads a picture to a certain space on the website and specifies to share the picture with one or several or all of the members of said specific group; the website is connected to the electronic photo frame corresponding to the specified member and transmits the picture to the electronic photo frame. Electronic photo frames in different spaces can thus browse the same picture, and since the transmission speed is very fast, users of the electronic photo frame can enjoy pictures sent by other members almost in real time.

However, the memory space of the existing electronic photo frame is generally not very large, whereas digital pictures are becoming larger and larger, so that the memory space often overflows, while transferring the pictures that are to be saved to other fixed storage media is not very convenient. The problem can be solved, of course, by increasing the space of the storage medium, but this will raise manufacturing costs and the price of the electronic photo frame.

### OBJECT AND SUMMARY OF THE INVENTION

An object of the invention is to provide an improvement electronic device and method to manage content.

The electronic device (10) comprising:

a receiving unit (11) for receiving a new content;

a determining unit (12) for determining that the available memory space of the electronic device is insufficient; and

a selecting unit (13) for selecting an old content to be re-arranged according to a pre-set instruction.

The electronic device of the invention can receive new content and re-arrange old content when the memory space of the electronic device is insufficient. The electronic device of the present invention can thus receive and store contents more conveniently and flexibly with low cost of hardware.

The present invention further includes a method using the electronic device to manage contents.

### BRIEF DESCRIPTION OF THE DRAWINGS

FIG. 1 is a schematic diagram of an electronic device according to one embodiment of the present invention,

FIG. 2 is a flow chart of a method of managing contents according to one embodiment of the invention.

### DESCRIPTION OF EMBODIMENTS

Transmission of contents between the server and the an electronic device requires a corresponding protocol to be configured between them, so that software for achieving the corresponding function needs to be installed between the server and the electronic device. The electronic device can be a photo frame, personal digital assistant, a laptop etc. The content can be pictures, audio, video, images, text documents etc. As will be evident to those skilled in the art, such software can be described in various languages, such as C, VC++, VB, LINIX, etc. Since the code languages of the software are not the major concern of the present invention, they will not be further described.

The electronic device receives the services provided by the server, so that it is necessary to first describe the network that provides such services.

Specifically, the server may receive a user's registration to create one or more user groups in the server storage space. Such user groups have a public server storage space for storing contents. Each member of the group may also have his/her own private sub-space. The user group is generally created on the basis of certain personal relationships, such as families, friends, school fellows, colleagues, etc. Such a group generally includes more than one member. The group members can be classified into common members and special members, and, in practice, members of different classes may have different rights in the operation of the group. The members herein correspond to the specific electronic devices through, for example, the IP protocol addresses, etc.

An electronic device transmits a content to the shared memory space of the server through the network, and selects the names of the members that can browse said content from the available group members, such as “Zhang San”, “Li Si”, etc. Subsequently, the server transmits said content to the electronic devices corresponding to the group members.

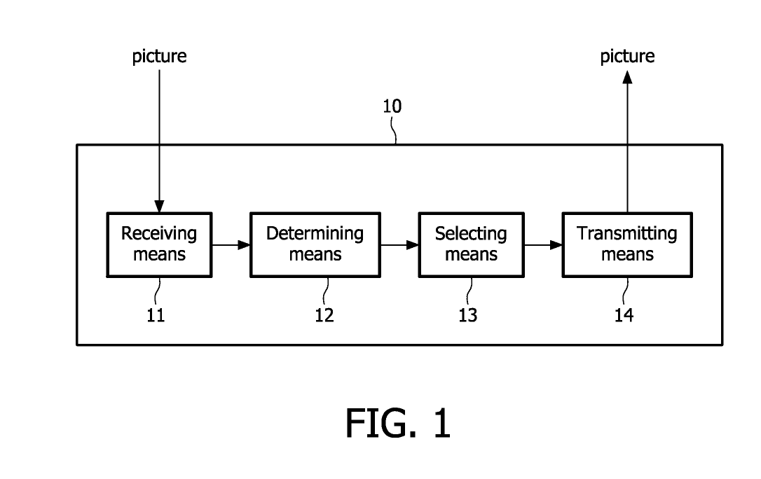

As is shown in FIG. 1, the electronic device 10 according to one embodiment of the present invention comprises a receiving unit 11, a determining unit 12, a selecting unit 13, and a transmitting unit 14.

The receiving unit 11 is used for receiving a new content. There may be one or more contents that are being received, and the received content may come from a server (not shown in the Figures) or other wireless devices.

The determining unit 12 is used for determining that the available memory space of the electronic device 10 is insufficient. The determining unit 12 can first determine the size of the received content, then determine the capacity of the available memory space of the electronic device 10, and finally determine if the memory of the electronic device has space enough to accommodate the received content.

The selecting unit 13 is used for selecting an old content to be re-arranged according to a pre-set instruction. The selected content is to be re-arranged by the way of being overflowed to the server or being overwritten by the received content.

The selecting unit 13 can also select the content to re-arranged in accordance with the size of the received content, the available memory space of the electronic device and the pre-set instruction, after the determining unit 12 determines that the memory space is insufficient.

The pre-set instruction can be pre-set in the electronic device 10 by a corresponding manufacturer, or by a user, or by a cooperator of the server. The selecting unit 13 is further configured to form an overflow list in accordance with the selected contents to be overflowed.

The pre-set instruction may include:

1). Refusing to store/browse a new content. The criterion that the user does not want to store/browse a new content can be formulated according to the user's preference or the system security of the electronic device.

2). Selecting an old content to be re-arranged on the basis of the pre-set user's preference, storage time of content, content quality, category etc. For example, the contents stored in the electronic device 10 for a long time are re-arranged first, the contents of poor quality are re-arranged first, the contents that the user does not like are overflowed first, etc.

3) Overwriting the selected old content or overflowing the selected old content to a server or other wireless devices.

The transmitting unit 14 is configured to transmit the selected content to be overflowed to a server or other wireless devices. The transmitting unit 14 is further configured to transmit the selected content to a server in accordance with the overflow list. The transmitted contents may include additional information which can be pre-set in the electronic device 10 by its manufacturer, or by the cooperator of the server, or by a user. Said additional information may be a password for locking the content to be overflowed, the name list of the users for sharing the overflowed content, time and/or way of flowing back the overflowed content, etc. There may be one or more overflowed contents, each of which may have different additional information. If the overflowed contents are flowed back from the server, the receiving unit 11 is also used for receiving said contents that are flowed back from the server.

The receiving unit 11 receives contents from the server or other wireless devices, and the received contents are temporarily reserved in a buffer of the electronic device to be browsed or stored. If said received contents are to be stored for a long time, after the transmitting unit 14 finishes the transmission of the contents to be overflowed, the transmitted contents are eliminated from the memory space of the electronic device 10, while the received contents stored in the buffer are transferred to the memory space of the electronic device 10.

The functions of the above-mentioned units of the electronic device can be controlled by a central processor. The electronic device can receive contents from other electronic devices through a server transmitted, can also transmit the old contents to other electronic devices through the server, when the memory space of the electronic device is insufficient. Moreover, the overflowed contents can be flowed back to the memory space of the electronic device when the overflowed contents can be re-stored at a later instant.

The electronic device of the embodiment described above can be pre-set according to the requirements of the user, the manufacturer or the cooperator, operating in at least one of the two following modes:

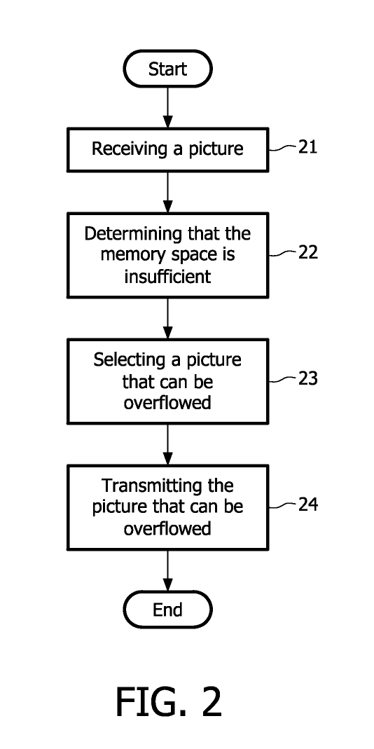

FIG. 2 depicts a flow chart of a method of managing content according to one embodiment of the invention. The method comprises the following steps.

The first step is to receive 21 a new content. The received contents may come from a server or other wireless devices. There may be one or more received contents.

The second step is to determine 22 that the available memory space of the electronic device is insufficient. The determining step may first determine the size of the received contents, then determine the capacity of the available memory space of the electronic device, and finally determine if the memory of the electronic device has space enough to hold the received content.

The third step is to select 23 an old content that to be re-arranged according to a pre-set instruction. The selected content can be re-arranged by the way of being overflowed to a server or being overwritten by the received content.

The selecting step 23 may be also intended to select the old content to be re-arranged in accordance with the size of the received contents, the available memory space of the electronic device and the pre-set instruction. The pre-set instruction can be pre-set in the electronic device by its manufacturer, or by the cooperator of the server, or by a user. The selecting step 23 further comprises forming an overflow list in accordance with the selected contents. Said pre-set instruction may include:

1). Refusing to store/browse the new content. The criterion that the user does not want to store/browse a new content can be formulated according to the user's preference or the system security of the electronic device.

2). Selecting an old content to be re-arranged on the basis of the pre-set user's preference, storage time of content, content quality, category etc. For example, the contents stored in the electronic device 10 for a long time are re-arranged first, the contents of poor quality are re-arranged first, the contents that the user does not like are overflowed first, etc.

3) Overwriting the selected old content or overflowing the selected old content to a server or other wireless device.

The fourth step is to transmit 24 the selected content to be overflowed to a server. The transmitting step 24 is further intended to transmit the content to be overflowed to a server in accordance with the overflow list. The transmitted contents may include additional information which can be pre-set in the electronic device 10 by its manufacturer, or by the cooperator of the server, or by a user. Said additional information may be a password for locking the content to be overflowed, the name list of the users for sharing the overflowed content, time and/or way of flowing back the overflowed content, etc. There may be one or more overflowed contents, each of which may have different additional information. If the overflowed contents are flowed back by the server, the receiving unit 11 is also used for receiving said contents that are flowed back.

The receiving step 21 is further intended to receive contents from the server or other wireless devices, and the received contents are temporarily reserved in the buffer of the electronic device to be browsed or stored. If said received contents are to be stored for a long time, after the transmitting step 24 completes the transmission of the contents to be overflowed to the server or other wireless device, the transmitted contents are eliminated from the memory space of the electronic device 10, while the received contents stored in the buffer are transferred to the memory space of the electronic device 10.

The receiving step 21 is further intended to receive the transmitted content back.

In the following, two modes (or examples) are given for illustrating electronic device according to the invention.

Mode 1:

To receive contents in real time/periodically and storing them in the memory space of the electronic device without browsing them. When the available memory space is insufficient, the contents to be overflowed are automatically selected according to the pre-set instruction and transmitted to a server or other wireless device, so as to free memory space for the newly received contents.

Mode 2:

To receive the contents uploaded by other electronic devices in real time/periodically, and browse every received content and determine if the received content needs to be saved, and storing the contents that need to be saved, meanwhile discarding the unnecessary contents.

In addition, if the memory space of the electronic device is found to be insufficient during storage, the contents that to re-arranged are selected according to the pre-set instruction, if the selected content is to be overflowed, then transmitting the selected content to the memory space of the server, and then said transmitted contents are deleted from the memory space of the electronic device, so as to free memory space for the new contents.

The two modes described above are not exclusive and independent, but can be mutually switched, for example, manually or automatically as set by a program.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the means claims enumerating several means or steps, several of these means or steps can be embodied by one and the same item of hardware. The usage of the words first, second and third, etcetera do not indicate any ordering. These words are to be interpreted as names.

1. An electronic device (10) comprising:
a receiving unit (11) for receiving a new content;
a determining unit (12) for determining that the available memory space of the electronic device is insufficient; and
a selecting unit (13) for selecting an old content to be re-arranged according to a pre-set instruction.

2. An electronic device (10) as claimed in claim 1, wherein the selected content is to be re-arranged by the way of being overflowed or being overwritten according to the pre-set instruction.

3. An electronic device (10) as claimed in claim 2, further comprising a transmitting unit (14) for transmitting the selected content, when the selected content is to be overflow according to the pre-set instruction.

4. An electronic device (10) as claimed in claim 1, wherein the determining unit (12) is intended to first determine the size of the received content, then determine the capacity of the available memory space of the electronic device, and finally determine if the memory space of the electronic device is enough to hold the received content.

5. The electronic device (10) according to claim 3, wherein the selecting unit (13) is further configured to form an overflow list for the transmitting unit (14) to transmit the content.

6. The electronic device (10) according to claim 3, wherein the pre-set instruction includes:
a criterion of refusing to store/browse the new content, wherein the criterion comprises a user's preference or security,
a criterion of selecting the old content, wherein the criterion comprises a user's preference, storage time of content, content quality, or category, and
a criterion of overwriting the selected old content or overflowing the selected old content.

7. The electronic device (10) according to claim 3, wherein the transmitted content comprises additional information which is a password for locking the transmitted content, a name list of users for sharing the transmitted content, and a time and/or way of taking back the transmitted content.

8. A method of managing content, comprising the steps of:
receiving (21) a new content;
determining (22) that the available memory space of the electronic device (10) is insufficient;
selecting (23) an old content to be re-arranged according to a pre-set instruction; and

9. A method as claimed in claim 8, wherein the selected content is to be re-arranged by the way of overflowing or being overwritten according to the pre-set instruction.

10. A method as claimed in claim 9, further comprising a step of transmitting (24) the selected content, when the selected content is to be overflowed according to the pre-set instruction.

11. The method according to claim 8, wherein the determining step (22) is intended to first determine the size of the received content, then determine the capacity of the available memory space of the electronic device, and finally determine if the memory space of the electronic device is enough to hold the received content.

12. The method according to claim 10, wherein the selecting step (23) is further intended to form an overflow list so as to transmit (24) the selected content.

13. The method according to claim 9, wherein the pre-set instruction comprises:
a criterion of refusing to store/browse the new content, wherein the criterion comprises a user's preference or security,
a criterion of selecting the old content, wherein the criterion comprises a user's preference, storage time of content, content quality, or category, and
a criterion of overwriting the selected old content or overflowing the selected old content.

14. The method according to claim 10, wherein the transmitted content includes additional information which includes the password for locking the overflowed content, the name list of the users sharing the overflowed content, and the time and/or way of taking back the overflowed content.

15. A method as claimed in claim 10, wherein the receiving (21) step is further intended to receive the transmitted content back.
